(19) United States
(12) Patent Application Publication
(10) Pub. No.: US 2007/0121556 A1
(43) Pub. Date: May 31, 2007

(54) Optical code-division multiple-access network system employing central code assignment scheme and optical encoder and decoder for the network system

(76) Inventors: Sung Chan Cho, Daejeon-city (KR); Kwang Joon Kim, Daejeon-city (KR)

Correspondence Address: LADAS & PARRY LLP, 224 SOUTH MICHIGAN AVENUE, SUITE 1600, CHICAGO, IL, 60604, US

(21) Appl. No.: 11/603,477

(22) Filed: Nov. 22, 2006

(30) Foreign Application Priority Data
Nov. 26, 2005 (KR) 10-2005-0113847

(51) Int. Cl. H04B 7/216

(52) U.S. Cl. 370/335; 370/342; 370/441

(57) ABSTRACT

Provided are an optical code-division multiple-access (O-CDMA) network system and method and an optical encoder and decoder in the system. The O-CDMA network system includes a central station and at least one subscriber unit. In a code assigning method of the optical code-division multiple-access network system, first, the subscriber unit transmits a code assignment request signal to the central station. Then, the central station assigns a code to the subscriber unit. Thereafter, the subscriber unit programs an encoding and decoding code based on the assigned code. The optical encoder and decoder includes a refraction grating, arrayed optical waveguides, optical switches, and optical reflectors. Therefore, a central code assignment scheme can be achieved, and programming of the encoder and decoder is possible.

### CROSS-REFERENCE TO RELATED PATENT APPLICATION

This application claims the benefit of Korean Patent Application No. 10-2005-0113847, filed on Nov. 26, 2005, in the Korean Intellectual Property Office, the disclosure of which is incorporated herein in its entirety by reference.

### BACKGROUND OF THE INVENTION

1. Field of the Invention

The present invention relates to an optical code-division multiple-access (O-CDMA) network system employing a central code assignment scheme and a programmable optical encoder and decoder in the optical code-division multiple-access network system.

2. Description of the Related Art

In an O-CDMA network, each channel is encoded with an assigned code and transmitted through a single transmission line, such as single mode fiber, in which the channels are multiplexed. The multiplexed signals transmitted through the transmission line are decoded by using the particular code assigned to extract the original data from combined signals at the receiver.

U.S. Pat. No. 5,760,941 discloses an O-CDMA network employing optical encoding and decoding in an incoherent optical domain using bipolar codes and connecting each user to a star coupler.

In an O-CDMA method disclosed in U.S. Pub. No. 2004/0141499, data transmitted by communication terminals to an accommodation device is code-division multiplexed to solve data collision among channels of the communication terminals. Meanwhile, data transmitted by the accommodation device to the communications terminals is time-division multiplexed.

In an optical code-division multiple-access method disclosed in U.S. Pub. No. 2004/0208537, a passive optical network requires a complicated process such as media access control for upstream communications but uses an O-CDMA method to solve this problem.

However, in a case where a conventional O-CDMA network structure is applied to a general subscriber network, the encoder and the decoder of each subscriber are coded according to an assigned code. A central station in which data is distributed to the general subscribers must manage code assignment for general subscribers to avoid code collision.

If the number of general subscribers to be managed increases, it is difficult to manage the code assignment due to a code change or replace a programmable encoder and decoder because of damage. Also, encoders and decoders having fixed codes may cause an inventory problem. An optical encoder and decoder disclosed in U.S. Pub. No. 2004/0037500 is used for an O-CDMA based on one-dimensional spectral phase-encoded time-spreading. The optical encoder and decoder includes an arrayed waveguide grating (AWG) for wavelength demultiplexing, a phase shifter, and an AWG for wavelength multiplexing.

However, in such a conventional one-dimensional spectral phase encoder, operation characteristics of an AWG demultiplexer must be accurately symmetrical to those of an AWG multiplexer. However, the operation characteristics of the AWG demultiplexer and the AWG multiplexer may not be accurately symmetrical due to a manufacturing process error.

This failure in accurate symmetry deteriorates the operation characteristics of the optical coders. Also, a pair consisting of an AWG multiplexer and an AWG demultiplexer constitutes the encoder or decoder, and thus the overall size of the encoder or decoder is large.

One can decrease the encoder/decoder size and integrate coders with optical active devices if we form the AWG multiplexer and demultiplexer on an InP substrate. However, this results in high crosstalk between channels due to the high index contrast of the InP-based AWG multiplexer and demultiplexer.

An optical encoder and decoder disclosed in U.S. Pat. No. 6,711,313 is used for an O-CDMA network based on an incoherent 2-dimensional time/wavelength code. The optical encoder and decoder for incoherent 2-dimensional code uses an incoherent light source as a light source and include arrayed waveguide gratings for multiplexing/demultiplexing wavelength, two matrix optical switch nodes, and time delay lines having different delay times. Switching is performed so that a time delay varies in the optical switch nodes with respect to each wavelength, so as to perform a wavelength/time encoding and decoding function.

### SUMMARY OF THE INVENTION

The present invention provides an optical code-division multiple-access (O-CDMA) network system and method of assigning codes to dispersed subscribers by using a central code assignment scheme.

The present invention also provides a programmable encoder and decoder for an O-CDMA network.

According to an aspect of the present invention, there is provided a central station of an O-CDMA (optical code-division multiple-access) network system, comprising: a code assigner assigning a code to each of a plurality of subscriber units with reference to a predetermined code assignment table according to a code assignment request signal of each of the subscriber units; a code controller programming an encoding and decoding code based on the code assigned by the code assigner; and an encoder and decoder decoding an optical signal received from each of the subscriber units according to the programmed encoding and decoding code and encoding an optical signal to be transmitted to each of the subscriber units according to the programmed encoding and decoding code.

According to another aspect of the present invention, there is provided a subscriber unit of an O-CDMA network, comprising: a transceiver (a transmitter and a receiver) performing transceiving (transmission and reception) with a central station of the optical code-division multiple-access network; a code controller transmitting a code assignment request signal to the central station through the transceiver and programming an encoding and decoding code based on a code assigned in response to the code assignment request signal; and an encoder and decoder decoding a signal received from the central station according to the encoding and decoding code programmed by the code controller and encoding a signal to be transmitted to the central station according to the encoding and decoding code.

According to another aspect of the present invention, there is provided a method of assigning a code in an O-CDMA network that comprises a central station and at least one or more subscriber units, the method comprising: transmitting code assignment request signals to the central station using the subscriber units; assigning codes to the subscriber units using the central station; and programming an encoding and decoding code based on the assigned codes in the subscriber units.

According to another aspect of the present invention, there is provided an optical encoder and decoder comprising: an optical circulator classifying a received optical signal into one of an input signal and an output signal according to a direction of propagation of the optical signal; a first diffraction grating dividing the optical signal received from the optical circulator into optical signals according to wavelengths and allowing the optical signals to be incident on optical waveguides spatially separated and arranged according to wavelengths; and optical switches selectively transmitting some of the optical signals incident on the optical waveguides toward optical reflectors.

Therefore, a central code assignment scheme can be achieved, and programming of the encoder and decoder is possible.

### BRIEF DESCRIPTION OF THE DRAWINGS

The above and other features and advantages of the present invention will become more apparent by describing in detail exemplary embodiments thereof with reference to the attached drawings in which:

FIG. 1A is a block diagram of an optical code-division multiple-access (O-CDMA) network system according to an embodiment of the present invention;

FIG. 1B is a block diagram of an O-CDMA network system according to another embodiment of the present invention;

FIG. 2 is a flowchart illustrating a method of assigning a code in an optical code-division multiple-access network, according to an embodiment of the present invention;

FIG. 3 is a view illustrating a code programmable optical encoder and decoder according to an embodiment of the present invention; and

FIG. 4 is a view illustrating a code programmable optical encoder and decoder according to another embodiment of the present invention.

### DETAILED DESCRIPTION OF THE INVENTION

Hereinafter, an optical code-division multiple-access (O-CDMA) network system and an optical encoder and decoder will be described in detail with reference to the attached drawings, in which embodiments of the invention are shown.

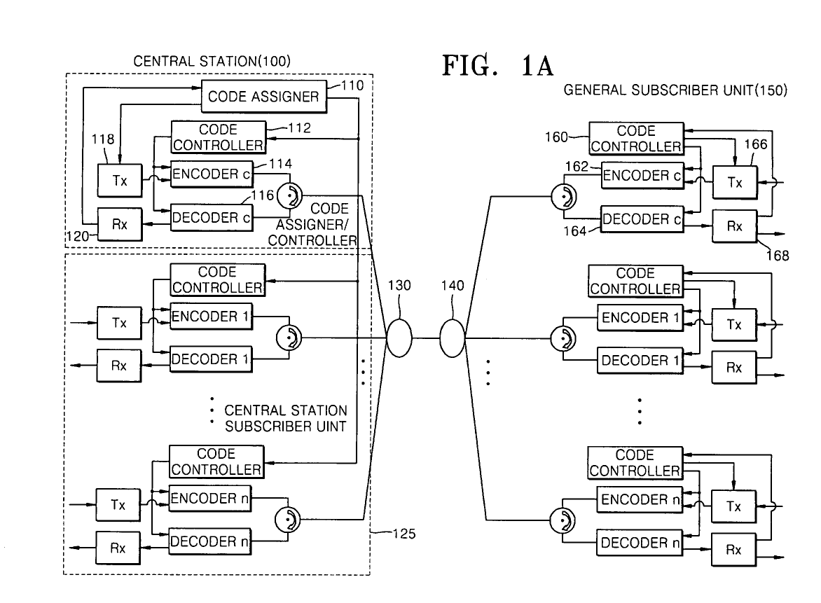

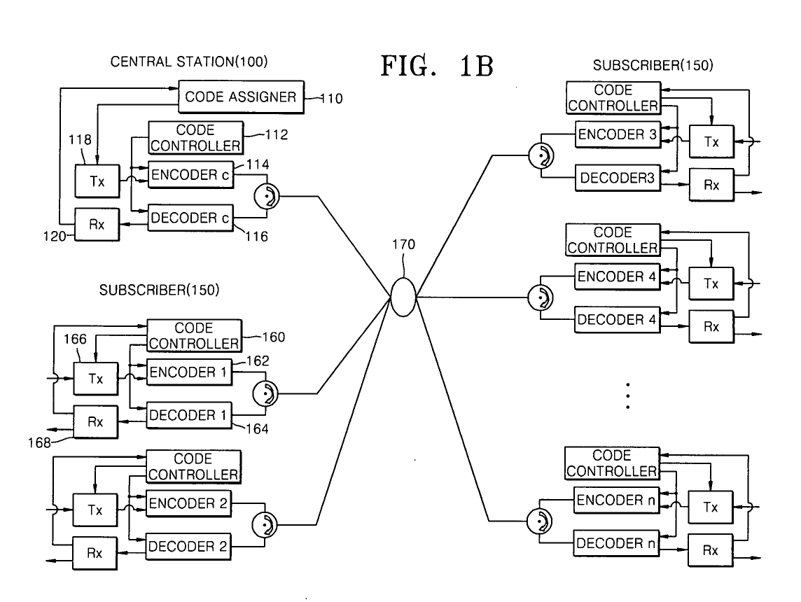

FIG. 1A is a block diagram of an O-CDMA network system according to an embodiment of the present invention.

Referring to FIG. 1A, the optical code-division multiple-access network system includes a central station 100, optical multiplexing/demultiplexing units 130 and 140, and a plurality of subscriber units (i.e., central station subscriber units 125 and general subscriber units 150). The central station 100 includes a code assigner 110, a code controller 112, an encoder 114, a decoder 116, an optical transmitter 118, and an optical receiver 120.

The optical receiver 120 receives an optical signal decoded by the decoder 116, converts the optical signal into an electrical signal, and transmits a request signal related to an assignment of an identification code (hereinafter referred to as a code) to the code assigner 110.

The optical transmitter 118 converts the electrical signal into an optical signal or modulates the electrical signal and transmits the converted or modulated signal to the central station subscriber units 125 and the general subscriber units 150 through the encoder 114.

When the code assigner 110 receives code-assignment request signals from the central station subscriber units 125 and the general subscriber unit 150 through the optical receiver 120, the code assigner 110 assigns codes to the central station subscriber units 125 and the general subscriber units 150 according to a code assignment table and transmits the codes to them through the optical transmitter 118. In other words, the code assigner 110 initializes and/or changes the codes of the central station subscriber units 125 and the general subscriber units 150 in order to control the codes.

More specifically, the code assigner 110 receives the code-assignment request signals from the central station subscriber units 125 and the general subscriber units 150 through the optical receiver 120 and transmits a signal, such as, a code assignment/change/initialization signal, to the central station subscriber units 125 and the general subscriber units 150 through the optical transmitter 118. The code assigner 110 also transmits a code assignment/change/initialization command to the code controller 112.

The code controller 112 controls code programs of the encoder 114 and the decoder 116 according to a command received from the code assigner 110.

A code controller 160 of each of the general subscriber units 150 receives the code assignment signal from the code assigner 110 of the central station 100 and programs an optical encoder 162 and an optical decoder 164 using an assigned code corresponding to the received code assignment signal. The general subscriber units 150 transmit the code assignment request signals to the code assigner 110 of the central station 100 during initial installation and code change/initialization.

The central station subscriber units 125 have the same structures as the general subscriber units 150. The central station subscriber units 125, each including a code controller, an encoder, a decoder, an optical transmitter, and an optical receiver, perform transmissions and receptions together with the general subscriber units 150 in a one-to-one correspondence.

The optical multiplexing/demultiplexing units 130 and 140 are passive devices and multiplex signals received from the central station subscriber units 125 and demultiplex signals received from each of the general subscriber units 150.

In more detail, each of the general subscriber units 150 includes a code controller 160, an encoder 162, a decoder 164, an optical transmitter 166, and an optical receiver 168.

The optical receiver 168 receives the optical signal from the central station 100, converts the optical signal into an electrical signal, transmits a command signal related to code assignment to the code controller 160, and transmits a data signal to a data processor (not shown).

The optical transmitter 166 converts an electric command or electric data related to code assignment into an optical signal or modulates the command or data and transmits the optical signal or the modulated signal to the central station 100 or the central station subscriber units 125 through the encoder 162.

The code controller 160 generates a code assignment request signal and transmits the same to the central station 100 through the optical transmitter 166. The code controller 160 also receives the command signal related to the code assignment through the optical receiver 168 and performs code change/initialization/control with respect to the encoder 162 and/or the decoder 164 according to the received command signal.

FIG. 1B is a block diagram of an O-CDMA network system according to another embodiment of the present invention.

Referring to FIG. 1B, the O-CDMA network system includes a central station 100, an optical splitter 170, and at least one or more subscriber units 150. The central station 100 includes a code assigner 110, a code controller 112, an encoder 114, a decoder 116, an optical transmitter 118, and an optical receiver 120.

The code assigner 110 receives code assignment request signals from the subscriber units 150 and assigns codes to the subscriber units 150 according to a code assignment table. The code assigner 110 also initializes and/or changes the codes of the subscriber units 150 in order to control the codes.

A code controller 160 of each of the subscriber units 150 receives a code assigned by the code assigner 110 of the central station 100 and programs the encoder 162 and the decoder 164 based on the received code. The code controller 160 also transmits a code assignment request signal to the code assigner 110 of the central station 110 during initial installation and code change/initialization.

The optical splitter 170 is a passive device that splits an optical signal of each of the subscriber units 150 in order to allow transmission of the optical signal to one of the other subscriber units.

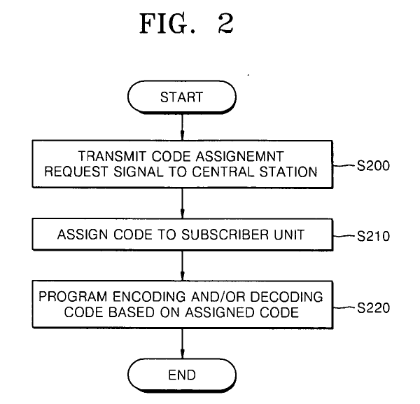

FIG. 2 is a flowchart illustrating a method of assigning a code in an O-CDMA network, according to an embodiment of the present invention. Referring to FIG. 2, in operation S200, a subscriber unit requests a code assignment of a central station. In operation S210, the central station assigns a code to the subscriber unit in response to the code assignment request, according to a predetermined code assignment table. In operation S220, the subscriber unit programs an encoder and a decoder based on the assigned code.

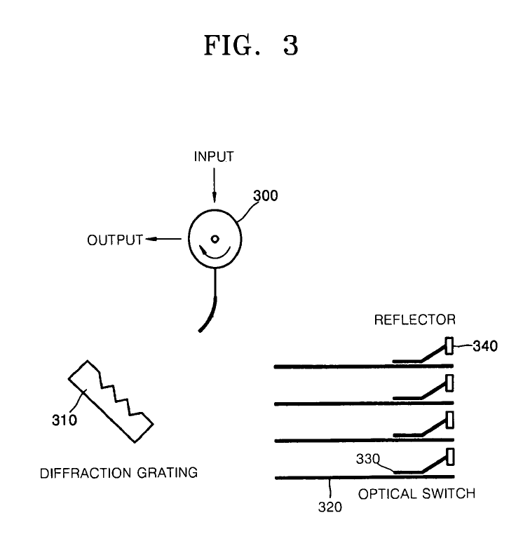

FIG. 3 illustrates a code programmable optical encoder and decoder according to an embodiment of the present invention. Referring to FIG. 3, the optical encoder and decoder includes a circulator 300, a diffraction grating 310, optical waveguides 320, optical switches 330, and optical reflectors 340. The optical encoder and decoder shown in FIG. 3 is an optical encoder and decoder used in an O-CDMA network using a unipolar one-dimensional wavelength optical intensity encoding method.

The circulator 300 determines an optical signal as either an input signal or an output signal based on a direction of propagation of the optical signal.

The diffraction grating 310, for example, an echelle diffraction grating, divides the optical signal received through the circulator 300 according to wavelengths and allows the divided optical signals to be incident on the optical waveguides 320 spatially separated and arranged according to the wavelengths. The diffraction grating 310 may be manufactured by etching a material having a high refraction index, such as a silica-based material, InP, or silicon. The diffraction grating 310 may be designed so as to have a refraction index greatly different than that of a material enclosing the diffraction grating 310, whereby a degree of integration rises.

The optical switches 330 are positioned between the optical waveguides 320 and the optical reflectors 340. When the optical switches 330 are switched on, corresponding optical signals are transmitted to the optical reflectors 340. When the optical switches 330 are switched off, corresponding optical signals are not transmitted to the optical reflectors 340.

The optical switches 330 are switched using an electro-optic effect, a thermo-optic effect, or a free plasma effect and are manufactured of horizontal couplers or crossing devices or vertical couplers or crossing devices.

The optical reflectors 340 are positioned at rear ends of the optical switches 330 and reflect the optical signals. In a case where the optical switches 330 have a function of switching on and/or off reflection of the optical signals, the optical reflectors 340 may be omitted. The optical reflectors 340 may be metal-coated reflectors, multi-layered dielectric coatings, waveguide diffraction gratings, or optical fiber diffraction gratings.

The optical encoder and decoder shown in FIG. 3 selectively reflects the optical signals spatially divided according to wavelengths by the diffraction grating 310 using the optical switches 330 and encodes the wavelengths of the reflected optical signals at an output terminal. The wavelength-encoded optical signals pass through the same diffraction grating 310 (e.g., an echelle diffraction grating) in a reverse direction. Thus, a deterioration of optical encoding characteristics due to a manufacturing process error can be remarkably reduced.

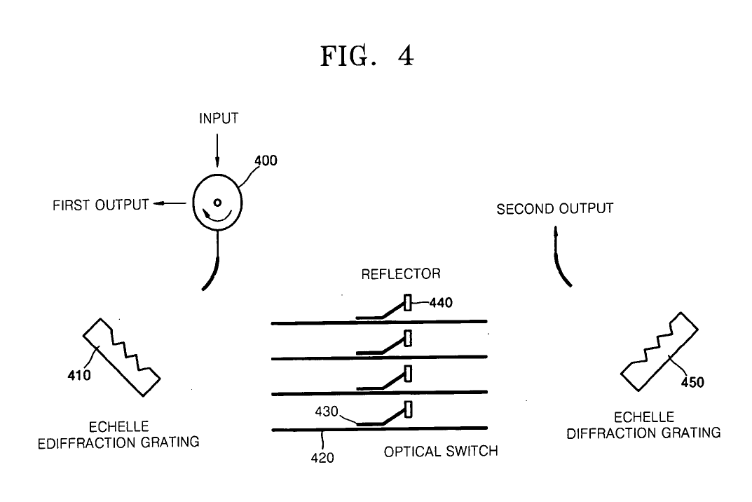

FIG. 4 illustrates a code programmable optical encoder and decoder according to another embodiment of the present invention. Referring to FIG. 4, the optical encoder and decoder includes a circulator 400, a first diffraction grating 410, optical waveguides 420, optical switches 430, optical reflectors 440, and a second diffraction grating 450. The optical encoder and decoder shown in FIG. 4 is an optical encoder and decoder used in an O-CDMA network using a bipolar one-directional wavelength optical intensity encoding method.

The circulator 400 determines an optical signal as either an input signal or an output signal based on a direction of propagation of the optical signal.

The first diffraction grating 410, for example, an echelle diffraction grating, divides the optical signal received through the circulator 400 according to wavelengths and allows the divided optical signals to be incident on the optical waveguides 420 spatially separated and arranged according to wavelengths. The first diffraction grating 410 has the same structure and function as the diffraction grating 310 shown in FIG. 3, and thus will not be described herein.

The optical switches 430 are positioned between the optical waveguides 420 and the optical reflectors 440. Some of the optical switches 430 are switched on in order to transmit corresponding optical signals toward corresponding optical reflectors 440, and the others are switched off so that corresponding optical signals are not transmitted to the optical reflectors 440. The optical switches 430 have the same structures and functions as the optical switches 330 shown in FIG. 3 and thus will not be described herein.

The optical reflectors 440 are positioned at rear ends of the optical switches 430 and reflect the optical signals. In a case where the optical switches 430 have functions of switching on and off the reflection of the optical signals, the optical reflectors 440 may be omitted.

The second diffraction grating 450 sums optical signals that have passed through the waveguides without being transmitted to the optical reflectors 440.

In other words, the optical encoder and decoder shown in FIG. 4 follows a method of selectively reflecting or transmitting optical signals spatially divided according to wavelengths by a diffraction grating, using optical switches, and wavelength-encoding the optical signals into bipolar signals at an output terminal.

As described above, according to the present invention, identification codes are freely assigned to encoders and decoders of dispersed subscribers or are changed using a central code assignment method so as to simplify the operation and management of an O-CDMA network. Also, an inventory problem can be prevented from being generated in the O-CDMA network.

In an optical encoder and decoder according to the present invention, an optical reflector allows both an input signal and an output signal to pass through the same arrayed waveguide grating (AWG) or the same echelle diffraction grating during encoding and decoding so that a deterioration of optical encoding and decoding characteristics due to an error occurring during the manufacture of the AWG or the echelle diffraction grating is minimized. Also, a degree of integration rises.

Furthermore, when the optical encoder and decoder is integrated with an active or passive optical device, an echelle diffraction grating can be used to prevent generation of a high crosstalk between channels in an AWG having a high index contrast.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A central station of an O-CDMA (optical code-division multiple-access) network system, comprising:
a code assigner assigning a code to each of a plurality of subscriber units with reference to a predetermined code assignment table according to a code assignment request signal of each of the subscriber units;
a code controller programming an encoding and decoding code based on the code assigned by the code assigner; and
an encoder and decoder decoding an optical signal received from each of the subscriber units according to the programmed encoding and decoding code and encoding an optical signal to be transmitted to each of the subscriber units according to the programmed encoding and decoding code.

2. The central station of claim 1, further comprising a transceiver (a transmitter and a receiver) transmitting the code assignment request signal to the code assigner if a received optical signal encoded by the encoder and decoder comprises the code assignment request signal, and transmitting the code through the encoder and decoder if the code is assigned to each of the subscriber units by the code assigner.

3. The central station of claim 1, wherein the encoder and decoder selectively reflects and transmits optical signals, into which the received optical signal is spatially divided according to wavelengths by a diffraction grating, using optical switches so as to encode the optical signal into one of a unipolar signal and a bipolar signal.

4. The central station of claim 1, wherein each of the subscriber units programs the encoding and decoding code based on the code assigned by the code assigner.

5. The central station of claim 1, wherein the subscriber units comprise general subscriber units connected to the central station via a splitter and central station subscriber units directly connected to the central station.

6. The central station of claim 1, wherein the code assigner issues a command to change or initialize the code assigned to each of the subscribers.

7. A subscriber unit of an O-CDMA network, comprising:
a transceiver (a transmitter and a receiver) performing transceiving (transmission and reception) with a central station of the optical code-division multiple-access network;
a code controller transmitting a code assignment request signal to the central station through the transceiver and programming an encoding and decoding code based on a code assigned in response to the code assignment request signal; and
an encoder and decoder decoding a signal received from the central station according to the encoding and decoding code programmed by the code controller and encoding a signal to be transmitted to the central station according to the encoding and decoding code.

8. The subscriber unit of claim 7, wherein when the code controller receives a code change and/or initialization command from the central station, the code controller changes and/or initializes a code of the encoder and decoder.

9. The subscriber unit of claim 7, wherein the encoder and decoder selectively reflects and transmits optical signals, into which the received optical signal is spatially divided according to wavelengths by a diffraction grating, using optical switches so as to encode the optical signal into one of a unipolar signal and a bipolar signal.

10. A method of assigning a code in an O-CDMA network that comprises a central station and at least one or more subscriber units, the method comprising:
transmitting code assignment request signals to the central station using the subscriber units;
assigning codes to the subscriber units using the central station; and
programming an encoding and decoding code based on the assigned codes in the subscriber units.

11. The method of claim 10, further comprising decoding signals received from the central station based on the programmed encoding and decoding code in the subscriber units and encoding signals to be transmitted to the central station based on the programmed encoding and decoding code in the subscriber units.

12. An optical encoder and decoder comprising:
an optical circulator classifying a received optical signal into one of an input signal and an output signal according to a direction of propagation of the optical signal;
a first diffraction grating dividing the optical signal received from the optical circulator into optical signals according to wavelengths and allowing the optical signals to be incident on optical waveguides spatially separated and arranged according to wavelengths; and
optical switches selectively transmitting some of the optical signals incident on the optical waveguides toward optical reflectors.

13. The optical encoder and decoder of claim 12, wherein the optical reflectors are positioned at rear ends of the optical switches and reflect the optical signals.

14. The optical encoder and decoder of claim 12, wherein the first diffraction grating is manufactured by etching a material having a refractive index greatly different than a refractive index of a material enclosing the first diffraction grating.

15. The optical encoder and decoder of claim 12, further comprising a second diffraction grating summing optical signals that have passed through the waveguides without being transmitted to the optical reflectors.
